(19) United States
(12) Patent Application Publication
(10) Pub. No.: US 2017/0098872 A1
(43) Pub. Date: Apr. 6, 2017

(54) Wireless health monitoring of battery cells

(71) Applicant: Oxfordian, LLC, Dallas, TX (US)

(72) Inventors: Bhanu Pratap Sood, Gaithersburg, MD (US); Michael G. Pecht, Hyattsville, MD (US)

(73) Assignee: Oxfordian, LLC, Dallas, TX (US)

(21) Appl. No.: 15/330,354

(22) Filed: Sep. 9, 2016

Related U.S. Application Data
(60) Provisional application No. 62/219,275, filed on Sep. 16, 2015.

(51) Int. Cl. H01M 10/48; G06K 7/10; G01L 1/22

(52) U.S. Cl. CPC H01M 10/48; G01L 1/2262; G06K 7/10297; H01M 2010/4271

(57) ABSTRACT

A strain gauge sensor system is disclosed for monitoring changes in stain of a battery surface, said change in strain indicative of internal changes in the battery. The sensor system comprises a wire grid based sensor, the sensor electrically connected though for example a Wheatstone bridge to an RFID tag. In the presence of an RFID reader, the sensor system is activated, a signal representative of the resistance of the wire grid (and thus grid strain) transmitted to the reader, and the resistance value compared to resistance values for the healthy state of the battery.

### FIELD OF INVENTION

The present invention relates to a method and apparatus for monitoring the health of battery cells by monitoring internal battery cell strain by means of one or more embedded strain gauge sensor systems, said system comprising a wire grid stain gauge in combination with an RFID tag. When the system is queried by an RFID reader, a reading is generated, the reading containing strain information, which is then wirelessly transmitted to an external device for analysis.

### BACKGROUND OF THE INVENTION

Lithium-ion batteries are an integral part of daily life. These batteries have been applied as the portable power source in numerous systems including cellular phones, digital cameras, electric vehicles, and unmanned aerial vehicles. These batteries are appealing because they have high energy and power densities, long cycle lives, and perform well under a wide range of discharge conditions. With the growing electric vehicle market, the use of batteries is expected to increase rapidly and it is imperative to manage the reliability and maintenance requirements associated with large scale battery usage.

Battery cells evolve gases during the charge-discharge process and during use conditions. The evolution of gaseous products, such as carbon dioxide (CO2), methane (CH4), and ethane (C2H4), is documented in literature. Gas generation in lithium-ion batteries can occur for a number of reasons. As a cell is charged and discharged, the electrodes expand and contract as a result of lithium intercalation mechanisms. As shown in the schematic in FIG. 1, lithium ion intercalates between layers of a graphite anode, causing a volumetric expansion of approximately 10%. Graphite is a commonly used anode material, and it is known to form a passivating layer called the solid electrolyte interphase (SEI) layer.

Reactions between graphite and the organic electrolyte commonly used in lithium-ion technology cause this film formation while releasing gas as a byproduct. Lithium ions are able to pass through this layer; however, particle intercalation stress can cause the graphite particles to fracture and electrode expansion can create cracks in the SEI layer. Particle fracture and SEI layer cracking causes fresh reaction sites on the graphite anode, and the consumption of active material during these side reactions is a source of degradation in lithium-ion batteries. These degradation mechanisms are related to usual charge-discharge cycling, intermittent operation at elevated temperature that is within the specified operating limits or, attributed to mechanical and thermo-mechanical stresses acting on the cell during operation.

The build-up of gases within the cell cause deformation of the cell walls, this deformation increases the internal stresses on various interfaces within the cell. Vital interfaces where degradation is prevalent inside a lithium-ion battery include the interface between the metallic anode current collector and anode active material, the metallic cathode current collector and cathode material. Numerous publications have correlated the degradation and change in state of these interfaces to loss of battery capacity and failure.

The volumetric expansion of the electrode particles can cause stress concentrations that can ruffle the electrode and cause a loss of connectivity between the electrode active material particles and the electronically conductive particles included in the electrode matrix. Additionally, separation or delamination of the electrode and the current collector can occur. As a result, the useful capacity of the battery is decreased due to the battery's reduced charge transfer capabilities.

In addition to the performance-based failure where degradation results in insufficient power or a decrease in the deliverable energy, catastrophic failures of batteries can result in explosion, fire, and destruction of the host-device. Lithium-ion batteries continue to experience catastrophic failures. Catastrophic failures are usually labeled as thermal runaway, or a series of escalating exothermic reactions that generate significant quantities of gas within the battery that eventually leads to explosion and fire.

If heat is generated inside a battery or in close proximity to the battery, and the heat generation rate outweighs the heat dissipation rate, the battery is at risk of entering thermal runaway. The source of heat generation could be elevated ambient temperatures, overcharge of the battery, or a short circuit. Particularly problematic is an internal short circuit where the anode and cathode make direct contact and rapid heat and gas generation is possible. Once a short circuit is initiated, it is difficult to avoid thermal runaway.

Advanced warning of conditions leading up to thermal runaway allow for mitigation strategies to improve the safety of battery powered systems. This invention provides a fault detection methodology for sensing precursors to catastrophic failure, through the detection of structural changes in the cell due to gas evolution.

This invention allows for the identification of various levels of gas generation in a battery cell or battery pack for improved safety. When a battery is overcharged, gas can begin to build up in the cell body. This is a more controllable and repeatable process than an internal short circuit.

Laboratory based strain measurements and monitoring techniques are hard to implement for fielded battery cells because of wiring and instrumentation required to gather the cell level strain data. What is needed is a reliable, non-invasive technique for health monitoring and inspection of lithium-ion batteries.

### SUMMARY OF THE INVENTION

The present invention involves a setup for monitoring battery cell state by means of a strain gauge sensor system including a sensor and an RFID tag. The strain gauge sensor system is used for monitoring the cell swelling and electrode expansion phenomenon observed during the charge-discharge cycling of a battery.

Strain is caused by an external influence or an internal effect. Strain gauge sensors convert force, pressure, tension, weight into a change in electrical resistance which can then be measured. In one embodiment, a strain gauge consists of a foil wire grid that is bonded directly to the surface to be monitored for strain by a thin layer of adhesive. When the surface undergoes deformation, the resulting change in surface length is sensed by the resistor and the corresponding strain is measured in terms of the changes in electrical resistance of the foil wire, which varies with the strain. The adhesive serves as an electrical insulator between the foil grid and the surface.

In order to measure strain, according to the invention, a strain gauge sensor system is provided in which a strain gauge is connected to an electric circuit that is sensitive to changes in resistance (i.e. a Wheatstone bridge) corresponding to strain. A Wheatstone bridge is a divided bridge circuit used for the measurement of static or dynamic electrical resistance. The operation of a Wheatsone bridge circuit is well known, and the circuitry of the bridge itself does not comprise an element of the invention.

In one embodiment, one or more strain sensors are placed on the skin of the cell, and appropriately connected to the circuitry of the Wheatstone bridge. The number of strain gauges depends on the cell size and battery configuration. In one arrangement, strain gauges are placed on opposite sides of a cell. In this arrangement, effective output for strain can be measured by two gauges. In another embodiment, the Wheatstone bridge circuitry can be located in the RFID reader or in another peripheral, and the change in resistance of the sensor calculated by the reader or other peripheral.

The strain gauge sensor can be placed on the external skin of the cell. The strain measured on the external side of the cell provides an assessment of the internal state of the cell, including the state of side reactions, by products and degradation states.

In another embodiment, strain gauge sensors can be encased into the casing of the cell. The casings are usually multilayers structures, with each layer serving a specific mechanical, chemical or electro-chemical purpose. The placement of the strain gage sensor is at a location that is conducive for cell strain measurements. The strain measured on the encasement of the cell provides an assessment of the internal state of the cell, including the state of side reactions, by products and degradation states.

The cell being monitored with the sensor can be one of a battery pack that consists of multiple batteries connected in series, parallel or a combination. Multiple strain sensors can be arranged either internal to the casing of the cell, outside the cell or both on the inside and the outside of the cell.

Radio-frequency identification (RFID) involves use of electromagnetic fields to transfer data. Tags derive energy from the interrogating radio waves of a RFID reader and act as passive transponders. RFID tag does not need to be in line-of-sight of the RFID reader and may be hidden or embedded.

One, two or multiple strain gauge sensors are connected to a passive RFID tag. The passive RFID tag is connected to a RFID antenna. The passive RFID tag and the antenna are placed in an embodiment on the skin of a cell along with the strain gauge sensor. The RFID tag and the antenna can also be placed internal to the casing of the cell or in any other configuration with respect to the strain gauge sensor and the cell.

RFID technology is well known and further details of the operation of this technology is well understood, and as such it is not further described herein. RFID systems are commercially available, and as a general matter, almost any one of these units may be used, subject to the design requirements for a particular monitoring system. Exemplary of RFID readers/systems that may be used include Motorola DS9808-R RFID Reader, the Alien ALH-9011 Handheld RFID Reader or the Baracoda or Kan RFID Reader.

After placement of the strain gauge sensor, the strain gauge is calibrated. Afterwards, a baseline or “healthy” strain data is generated and acquired. The baseline strain can be captured immediately after placement of the gauge on the cell, or prior to the first use of a cell in its application environment. There can be many other points in time or cycle life when the baseline strain can be captured or reset.

The strain gauge sensor generates strain data as the cell undergoes mechanical strain during normal use, during charge and discharge due to the mechanisms mentioned above. The changes to the strain due to deformation within the cell and on the cell walls are captured by the strain gauge sensors.

When the passive RFID tag is energized wirelessly by a RFID reader through the passive RFID antenna, a signal is generated at the RFID. The signal is transmitted to the strain gauge sensor and a voltage pulse is passed through the sensor. Due to the changes in the strain values, a change in potential is observed across the strain gauge sensor. This change in the potential corresponds to the amount of strain that is applied to the gauge by the cell. This strain values can be inside a “healthy” strain envelope that was captured during the baselining step

This strain values can be related to one or more degradation mechanisms listed above. After the potential drop and strain data is measured, the strain values are transferred to the RFID chip. This strain data is transmitted to the passive RFID reader through the antenna. As a result, the strain data measured on the skin of the cell or within the layers of the casement of the cell is transmitted through the RFID antenna, the chip, and the strain gauge sensor to the reader.

### BRIEF DESCRIPTION OF THE DRAWINGS

The present invention is described with respect to particular exemplary embodiments thereof and reference is accordingly made to the drawings in which:

FIG. 1 includes FIG. 1A and 1B, FIG. 1A is schematic illustrating Lithium ions before intercalation, and FIG. 1B a schematic illustrating the intercalation of Lithium ions between layers of a graphite anode, causing a volumetric expansion.

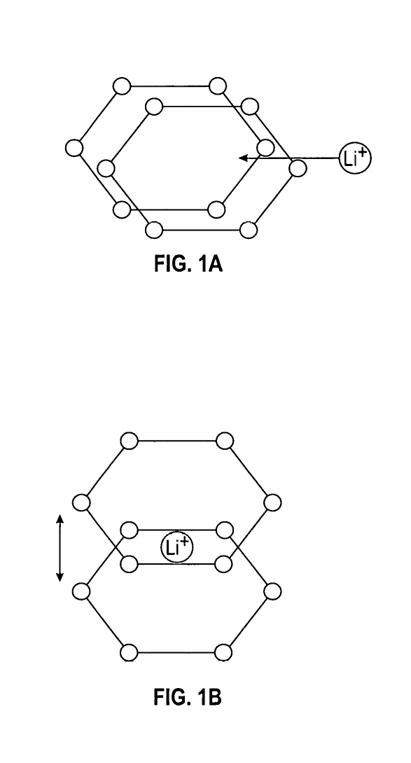

FIG. 2 includes FIG. 2A, an illustration of a new, uncycled cell, FIG. 2B, an illustration of that same cell after multiple charge/discharge cycles, and FIG. 2C an X-ray image of a cell after multiple charge/discharge cycles. The X-ray image shows the ruffled state of the electrodes after the battery is subjected to charge-discharge cycles.

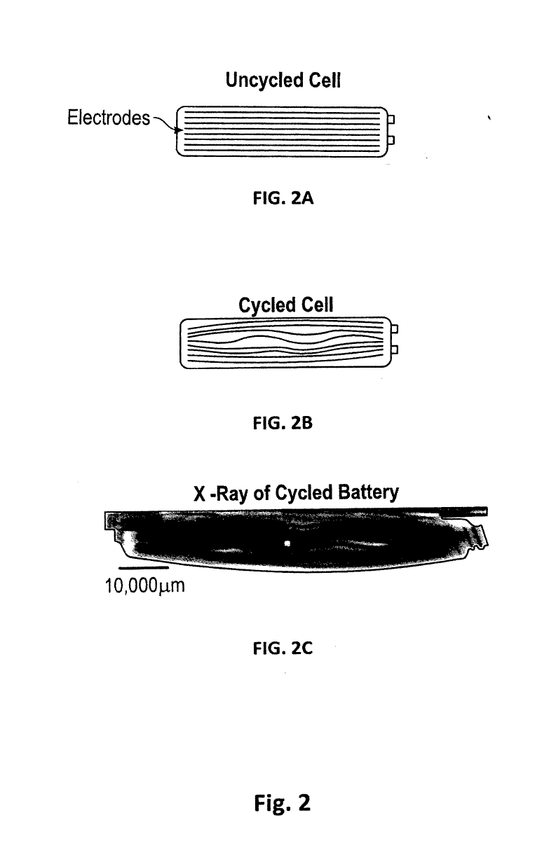

FIG. 3 is a schematic of a battery housing showing the placement of embedded RFID die, embedded antenna and strain sensor. The schematic of FIG. 3A shows these components in connection with a new, uncycled battery, and FIG. 3B illustrates the same combination of components for a battery which has undergone multiple charge/discharge cycles.

FIG. 4 is an electrical schematic of RFID system containing reader and chip.

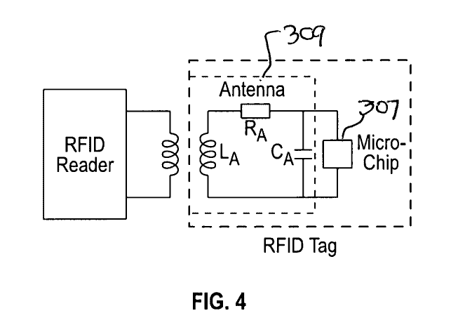

### DETAILED DESCRIPTION OF THE INVENTION

A general example of the embodiments of the invention is described below with reference to the accompanying drawings. The invention is not limited to the construction set forth and may take on many forms embodied as both hardware and/or software. The invention may be embodied as an apparatus, a system, a method, or a computer program. The numbers are used to refer to elements in the drawings.

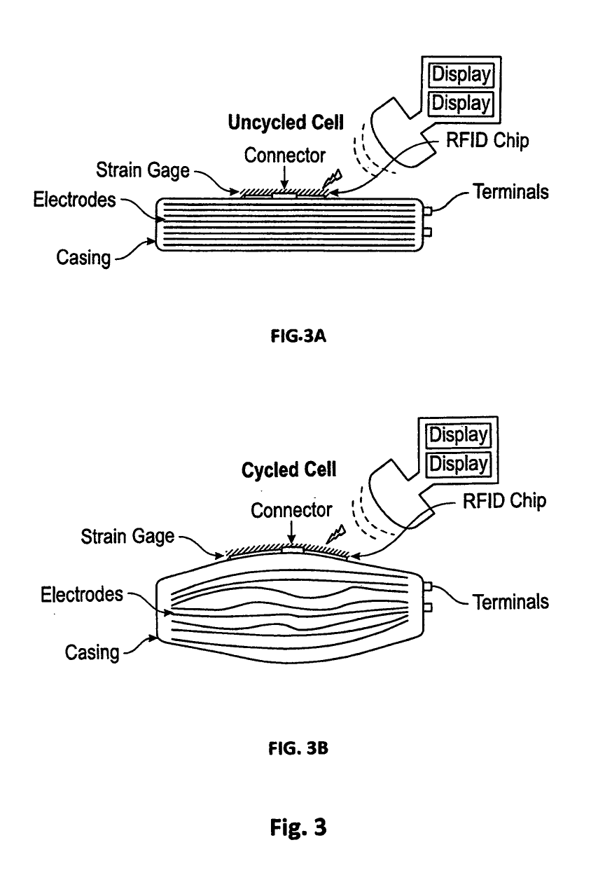

With reference to FIG. 3, a bi-directional strain gauge 301 is bonded to or embedded in the solid material of the outer skin or surface 303 of a battery cell 305 or any other surface which is properly prepared. Gauge 301 is electrically connected to passive RFID chip 307, which in turn is connected to passive RFID antenna 309.

In the case of an attached system, the surface to which the system is to be attached must be property prepared. While this can be can be achieved in more than one way, in one embodiment specific procedures and techniques which may be employed are described here below. The techniques described are exemplary only and do not comprise an element of the invention. Other techniques may be used so long as a mechanically secure, non-intrusive and electrically isolated attachment is achieved.

The purpose of surface preparation is to develop a chemically clean surface having a roughness appropriate to the gage installation requirements, a surface alkalinity corresponding to a pH of approximately 7, and optionally visible gage layout lines for locating and orienting the strain gage.

Degreasing is performed to remove oils, greases, organic contaminants, and soluble chemical residues. Porous skin material may require additional surface preparation.

The surface preparation for gage installation is done when the surface is abraded to remove any loosely bonded adherents, and to develop a surface texture suitable for bonding. Abrading is done with silicon-carbide or equivalent of the appropriate grit. A surface in the 1.6-6.4 μm RMS, root mean square (RMS is the average of the profile height deviations from the mean line, recorded within the evaluation length) is prepared.

The location and orientation of strain gage on the cell surface is identified by marking the surface with reference lines at the point where the strain measurement is to be made. Criteria for placement can vary with the construction and geometry of the cell. In some cases the reference lines are placed at the center of the cell, where two diagonal imaginary lines intersect. In other cases, where the cell is cylindrical, the placement can be at the 90° and 270° angle orientations, at half the overall height of the cell.

The number of strain measurement locations per cell can range from one strain gauge per cell to one strain gauge on each face of the cell to a plurality of strain gauges per cell.

The orientation lines are made perpendicular to one another, with one line oriented in the direction of strain measurement.

After the layout and orientation lines are marked on the cell, a surface conditioner is applied repeatedly, and the surface scrubbed.

The next step in surface preparation is to bring the surface condition back to an optimum alkalinity and the surface is properly prepared for strain gauge bonding.

The gage is installed so that the triangular index marks defining the longitudinal and transverse axes of the grid are aligned with the reference lines on the test surface. Studies have shown that the expansion or change in strain on the surface of the cell, as a result of cycling or degradation is not uniform. The stain can be higher along the longitudinal axis and smaller along the transverse axis, or vice versa. The strain gage may be oriented along the grid or can be placed at an angle to the grid. In another embodiment of the invention, strain gages can be placed in concentric circle along the axial direction. In still another embodiment, the stain gauge wire sensor grid can be in the form of a series of concentric circles intersected by a number of radial wire spokes.

The strain gauge is placed at a location on the skin of the cell or internal to the cell battery at a location that is conducive for cell strain measurements When the strain gage sensor is applied to the outside of the cell, it makes it easier to retrofit the cell for strain measurement after the manufacturing processes.

A conductor on the cell skin is then applied by screen printing or stenciling conductive inks onto polymer films to directly create circuit traces. This polymer thick- film (PTF) method involves use of a PTF ink. The ink consist of a mixture of a polymer binder, and a finely granulated conductive material such as silver or resistive carbon. The PTF ink is applied to the cell surface. Terminals of the strain gauge are connected with the PTF circuitry on the cell surface via pressure contact or using another bonding method.

The termination of the PTF trace are connected to the RFID chip. The RFID chip exchanges data with a reader. The reader uses radio frequency signals. The RFID chip takes care of modulating and demodulating the radio frequency signals, as well as processing and storing data.

Various commercial available attachment methods are used to connect RFID with the PTF trace that connect to the strain gage.

The PTF traces also act as the external antenna for the RFID chip. The pattern, size and orientating of the PTF trace antenna is matched o obtain the best possible read rates from an external RFID reader.

The strain gauge sensor generates a change in resistance as the cell skin undergoes strain. As the cell undergoes changes in health due to mechanisms such as mechanical strain during operation, charge-discharge cycles or during storage, due to the mechanisms related to intercalation, gas generation and side reactions.

The change in resistance across the strain gage is passed on to the RFID which will correlate to changes in the characteristic impedance of the RFID tag. Changes in the impedance also affect the resonant frequency of the tag. In other embodiments of the invention, the RFID chip acquires readings at predetermined or randomly selected intervals from the strain gage sensor and stores these readings. In another embodiment, the RFID chip is programmed to act as an event detector and records strain values when they surpass beyond a certain preset limit. These preset limits are determined apriori using degradation assessment techniques and models. In these other embodiments, the sensor can be either draw power from the battery being monitored or, be powered by the structural changes in the battery using energy harvesting mechanisms that have the ability to transform mechanical strain energy into electrical charge, or be connected to a separate battery external to and affixed to the surface of the battery or battery pack being monitored.

This pairing of embedded passive radio frequency identification device chip with an embedded antenna coupled with the embedded strain gauge sensor is calibrated to work inside the battery cell.

### Components

The wireless strain gauge monitoring device of the present invention includes a strain gauge, a passive RFID die, an antenna, and associated circuitry.

The RFID tag contains at least two parts, one is an integrated circuit for storing and processing information, modulating and demodulating a RF signal, and other specialized functions. The second is an antenna for receiving and transmitting the strain signal.

### Component Placement

The selection of candidate cells for applying strain gauge sensors can be location based (within a multi-cell pack) for example, locations that are known to experience higher stresses. The health data is collected and transmitted to a battery management system.

### Collecting/Reading of Sensor Data

This strain gauge sensor and RFID in a first embodiment do not rely on the cell power, the setup is passive, until “awakened” by a RFID reader. The strain sensor, RFID transmitter and antenna can be incorporated into one cell that is part of a larger, multi-cell pack, or into every cell in a large, multi-cell pack. When the passive RFID tag is queried wirelessly by a RFID reader through the passive RFID antenna, a signal is generated at the RFID chip. The signal is transmitted over to the strain gauge sensor and a voltage pulse is passed through the sensor. Due to the changes in the strain values, a change in potential is observed across the strain gauge sensor. This change in the potential corresponds to the amount of strain that is applied to the gauge by the cell. This strain values can be inside a “healthy” strain envelope that was captured during the baselining step or can be related to the degradation mechanisms above.

After the potential drop and strain data is measured, the strain values are passed on to the RFID chip. This strain signal is then transmitted to the passive RFID reader through the antenna. As a result, the strain data measured on the skin of the cell or within the layers of the encasement of the cell is transmitted through the RFID antenna, the chip, the strain gauge sensor and back to the reader.

### Processing Sensor Data

The strain sensor data gathered wirelessly is supplies to a “look-up table” type grid for determination of health condition. If the return signal from the RFID and strain sensor corresponds to a strain level that is lower than a preset threshold for a degraded cell, then cell is considered healthy. If return signal from the RFID and strain sensor corresponds to a level that is above a threshold, warning is displayed to show degradation is excessive.

### Incorporation into Battery Management Systems

A battery management system is typically incorporated into a host systems, such as automobiles or backup power systems that utilize single cells or banks of cells arranged in series, parallel, or combination arrangements. A battery management system enables safe and reliable operation by performing state monitoring, charge control, and cell balancing (in multi-cell pack systems). A battery management system also monitors and controls the battery based on the safety circuitry incorporated within the battery packs. Whenever any abnormal conditions are detected, such as over-voltage or overheating, the BMS notifies the user and executes the preset corrective procedure. By incorporating the cell strain data into the battery management system, a layered structure of sensors for monitoring and data acquisition is created. This layered structure determines the state of the battery and helps to determine battery pack safety and reliability.

### Additional Applications

In addition to incorporating the wireless RFID based strain sensor into a battery management system, the technique has applications in a cell battery pack repair depot as a means of non-destructive and non-intrusive cell health assessment tool. A technician at the repair facility is equipped with the RFID reader. The technician can promptly scan the cell battery pack and gather cell health data in a wireless fashion by approaching the pack. This data is used for maintenance and downtime decisions.

The foregoing detailed description of the present invention is provided for purposes of illustration and is not intended to be exhaustive or to limit the invention to the embodiments disclosed, the scope of the invention limited only the clams hereto.

What we claim is:

1. A strain gauge sensor system for a battery cell which may be wirelessly monitored for signs of internal cell stress comprising:
a. a battery cell having an interior and exterior cell surface
b. a strain gauge sensor affixed to said cell, said sensor comprising a number of components including:
1) a wire mesh
2) an RFID chip; and,
3) an RFID antenna
wherein said components are electrically connected.

2. The strain gauge sensor system of claim 1 wherein the strain gauge sensor is mounted to the exterior of said cell surface.

3. The strain gauge sensor system claim 1 wherein the battery cell includes an outer casing, and the strain gauge sensor is mounted to the interior of said outer casing.

4. The strain gauge sensor system of claim 1 wherein the wire mesh is in the form of a wire grid.

5. The strain gauge sensor system of claim 1 wherein the wire mesh is in the form of concentric circles intersected by a plurality of radial wire spokes.

6. The strain gauge sensor of claim 1 further including a Wheatstone bridge, to which the wire mesh is electrically connected.

7. A method for monitoring the health of a battery cell by monitoring the change in internal stress of the cell, comprising;
a. bringing an RFID reader into communicative proximity to the battery cell of claim 1;
b. energizing the RFID reader to electrically activate the strain gauge sensor system of claim 1;
c. transmitting a value representing the electrical resistance of the wire grid; and,
d. comparing the resistance reading to a baseline stress profile for a healthy battery.

8. The method of claim 7, including the further step of issuing an electronic warning if the strain reading exceeds a preset threshold, said threshold established by reference to previous testing of the healthy battery cell.

9. The method of claim 7 where a reading is generated only in response to an RFID reader query of the sensor system.

10. The method of claim 7 in which the RFID chip receives multiple readings from the stain gauge sensor, and stores these readings, until said stored readings are transmitted to an RFID reader.
